(19) United States
(12) Patent Application Publication
(10) Pub. No.: US 2009/0255365 A1
(43) Pub. Date: Oct. 15, 2009

(54) PIEZOELECTRIC VIBRATION ABSORPTION SYSTEM AND METHOD

(75) Inventor: Jonathan Mark Bunne, Elkhorn, WI (US)

Correspondence Address: MICHAEL BEST & FRIEDRICH LLP, 100 E WISCONSIN AVENUE, Suite 3300, MILWAUKEE, WI, 53202, US

(73) Assignee: BUELL MOTORCYCLE COMPANY, East Troy, WI (US)

(21) Appl. No.: 12/102,180

(22) Filed: Apr. 14, 2008

(51) Int. Cl. B62K 21/00; B62K 11/00; F02B 75/06

(52) U.S. Cl. 74/551.2; 180/219; 123/192.2

(57) ABSTRACT

Piezoelectric vibration absorption system and method. In one embodiment, the invention provides a rider interface that includes a surface. A vibration dampening assembly is affixed to the surface. The vibration dampening assembly includes a piezoelectric element. A load element is electrically connected to the vibration dampening assembly such that the vibration dampening assembly dampens vibrations of the rider interface.

### BACKGROUND

The present invention relates to dampening mechanical vibrations in a motorcycle. A motorcycle can experience mechanical vibrations from a variety of sources. The vibrations can have adverse effects on a rider including discomfort, and, if subjected to the vibrations for an extended period of time, soreness. Many conventional dampening systems include heavy tuned masses mounted to an end of a handlebar of the motorcycle.

### SUMMARY

The present invention provides a motorcycle rider interface that includes a surface and a vibration dampening assembly. The vibration dampening assembly is affixed to the surface of the rider interface and includes a piezoelectric element and a load element. The piezoelectric element produces an electrical energy in response to a strain on the rider interface. The load element is electrically connected to the piezoelectric element such that the vibration dampening assembly dampens vibrations of the rider interface.

In another aspect, the present invention provides a method of dampening a vibration in a motorcycle. The method includes affixing a vibration dampening assembly to a surface of a rider interface and electrically connecting a load to the vibration dampening assembly. The vibration dampening assembly including a piezoelectric element. The method also includes converting a strain on the vibration dampening assembly to an electrical signal, which is dissipated by the load to dampen the vibration.

Other aspects of the invention will become apparent by consideration of the detailed description and accompanying drawings.

### BRIEF DESCRIPTION OF THE DRAWINGS

FIG. 1 illustrates a motorcycle embodying the present invention.

FIG. 2 schematically illustrates a set of vibration dampening assemblies of the motorcycle of FIG. 1.

FIG. 3 schematically illustrates a polarized piezoelectric of the vibration damping assembly of FIG. 2, illustrating no applied strain.

FIG. 4 schematically illustrates a polarized piezoelectric element of the vibration damping assembly of FIG. 2, illustrating an applied strain.

FIG. 5 schematically illustrates a vibration dampening assembly according to another construction of the invention.

FIG. 6 schematically illustrates a polarized piezoelectric element of the vibration damping assembly of FIG. 2, connected to a light emitting diode.

FIG. 7 schematically illustrates a polarized piezoelectric element of the vibration damping assembly of FIG. 2, connected to a battery.

FIG. 8 schematically illustrates an active vibration dampening assembly according to another construction of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

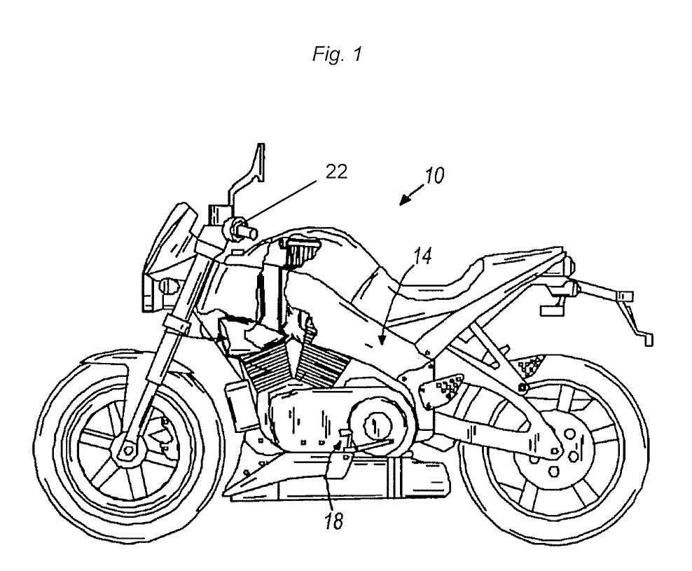

FIG. 1 illustrates a motorcycle 10 having a frame 14, an engine 18, and a handlebar 22. During operation, the motorcycle 10 is subject to mechanical strain from a variety of sources. The sources of mechanical strain include vibrations caused by, among other things, the engine 18, a speed of the motorcycle 10, a movement of a rider, or the road. Each source of vibration affects the motorcycle 10 differently, and each of the vibrations can occur at a different frequency.

The vibrations experienced by the motorcycle 10 also are manifested in different areas. For example, an exhaust pipe of the motorcycle 10 or handlebar 22, in many instances, experience significant mechanical vibrations. The vibrations experienced at the handlebar 22 are particularly important, as the handlebar 22 is a primary contact point between a rider and the motorcycle 10. Embodiments of the invention include ways of reducing the mechanical vibrations experienced at the handlebar 22. In other embodiments, mechanical vibrations are reduced at different rider interfaces, such as a seat, a console, a pedal, a foot peg, a floor board, or the like.

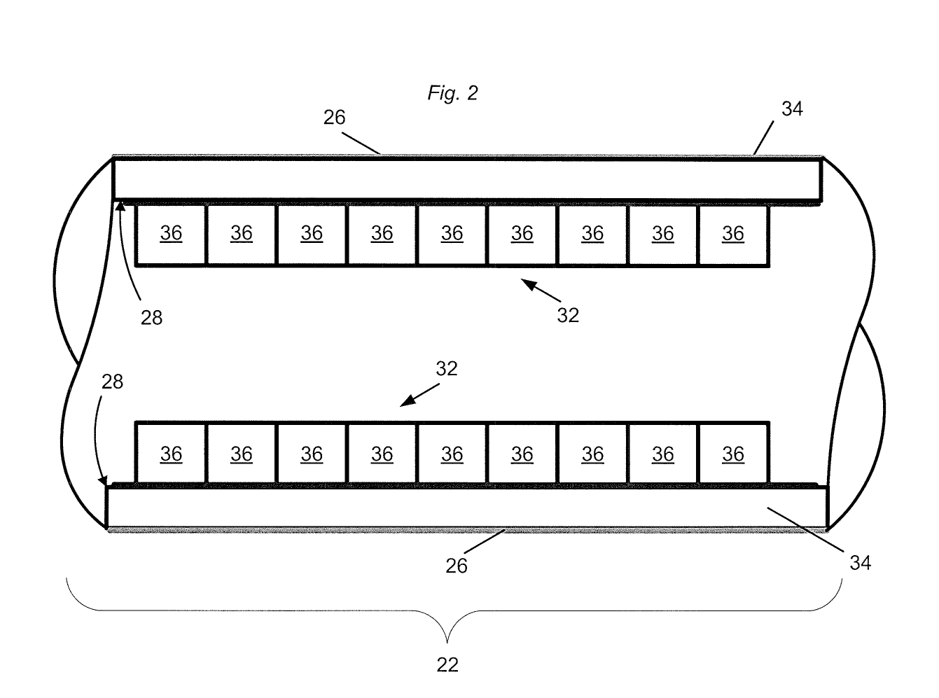

FIG. 2 illustrates a cross-sectioned portion of the handlebar 22. The handlebar 22 includes an outer surface 26, an inner surface 28, and two vibration dampening assemblies 32 including one or more piezoelectric elements 36 and one or more loads (not shown). The piezoelectric elements 36 are coupled to the inner surface 28 such that the vibration dampening assemblies 32 can provide stiffness to the handlebar 22. The vibration dampening assemblies 32 respond to an applied strain such as, for example, a mechanical vibration, by converting the applied strain to an electrical potential, which is dissipated in the corresponding load to reduce vibrations. A reduction in mechanical vibrations experienced by the rider is a product of how efficiently the assemblies 32 are able to convert the strain to electrical energy. The ability of the vibration dampening assemblies 32 to dampen an applied strain depends on, among other things, their size and placement. Depending on the embodiment of the invention, the vibration dampening assemblies 32 are arranged in different configurations, and each configuration is connected, via electrical leads, to an electrical load of the vibration dampening assembly 32. The vibration dampening assembly 32 includes at least one, and in some embodiments, many electrical loads.

The amount of vibration dampened by the vibration dampening assemblies 32, if implemented inefficiently, may only be a small percentage of the strain applied to the handlebar 22. As discussed above, the degree to which mechanical vibrations in the handlebar 22 are dampened depends on the size and location of the vibration dampening assemblies 32. The effectiveness of the vibration dampening assemblies 32 is also influenced by their location within the handlebar 22, as well as how the assemblies 32 are coupled to the handlebar 22. The vibration dampening assemblies 32 are advantageously placed at locations within the handlebar 22 that experience the most strain, and therefore, cause the vibration dampening assemblies 32 to dissipate the greatest amount of energy. The placement of the vibration dampening assemblies 32 varies with factors such as the type of motorcycle, the size of the engine, the shape of the handlebar, and the like. For example, in some embodiments, the vibration dampening assemblies 32 are placed at extremities of the handlebar 22 or at bends and joints of the handlebar 22. Additionally, as shown in FIG. 2, the vibration dampening assemblies 32 can be mounted to the interior of the handlebar 22 via an adhesive 34 such as an epoxy or other fastening material. In other embodiments of the invention, the handlebar 22 can include recesses to integrally mount the piezoelectric elements 36 in the handlebar 22.

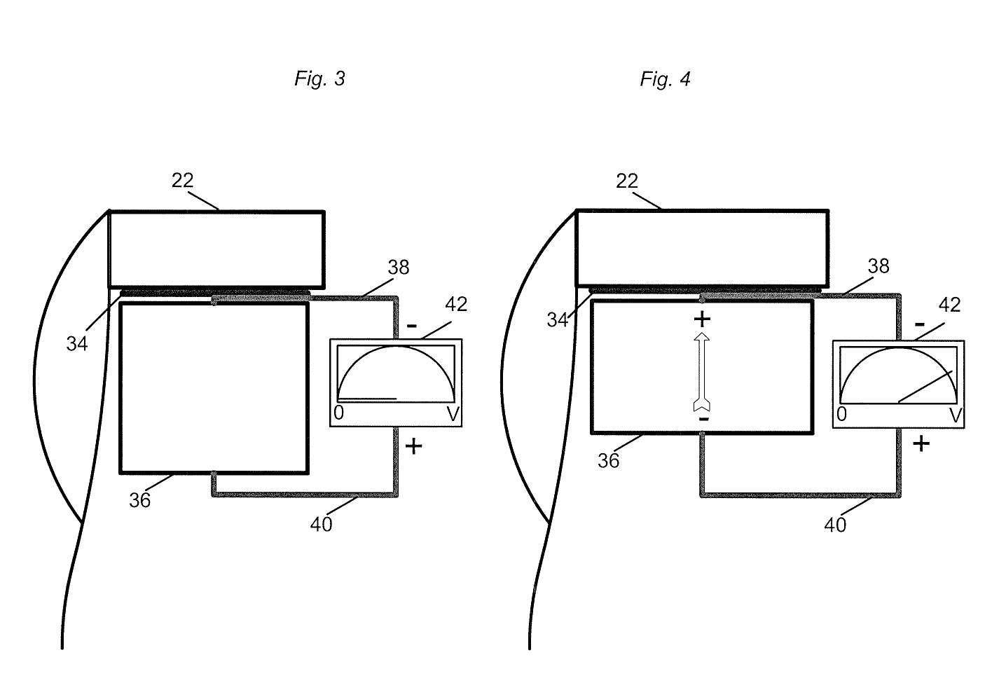

FIGS. 3 and 4 illustrate a piezoelectric element 36 from the vibration dampening assembly 32 in FIG. 2. In embodiments of the invention, one or more loads 42 (shown as voltage meters in FIGS. 3 and 4) are attached to the element 36 via a first lead 38 and a second lead 40 to receive the energy produced by the element 36 (e.g., to measure, dissipate, and/or store the energy). The element 36 in FIG. 3 is shown in a neutral position. While in the neutral position, no difference in electrical potential exists across the element 36. The element 36 is polarized with a positive sign indicating a positively polarized side, and a negative sign indicating the negatively polarized side. FIG. 4 illustrates the effect of a strain being placed on the element 36. If the strain is placed on the element 36 in the direction of the polarization (i.e. the element 36 experiences a strain perpendicular to the interior surface 28 of the handlebar 22) or if the element 36 is stretched in a direction perpendicular to the direction of polarization (i.e. the element 36 experiences a strain parallel to the interior surface 28 of the handlebar 22), a difference in electrical potential (i.e., a voltage) appears across the load 42 in the direction of the polarization. If a strain is placed on the element 36 in an opposite direction, the element 36 produces an electrical potential having an opposite polarity.

In some embodiments, the load 42 attached to the element 36 is a passive load. For example, the load 42 may be a resistor having first and second leads 38 and 40. The voltage that is generated across the element 36 is then dissipated by the resistor 42 in the form of heat. The voltage generated across the element 36 is a product of the vibrational frequency of the handlebar 22. A purely resistive passive load is able to dissipate a wide range of voltages and pass a wide range of currents. Therefore, the purely resistive passive load functions as an adaptive vibration dampening device capable of dampening a wide range of vibrational frequencies experienced by the handlebar 22. The voltage generated across the element 36 also depends on the type, size, and number of the piezoelectric elements 36 in the assembly 32. Accordingly, resistance values for the load 42 are selected to account for the variance in generated voltages.

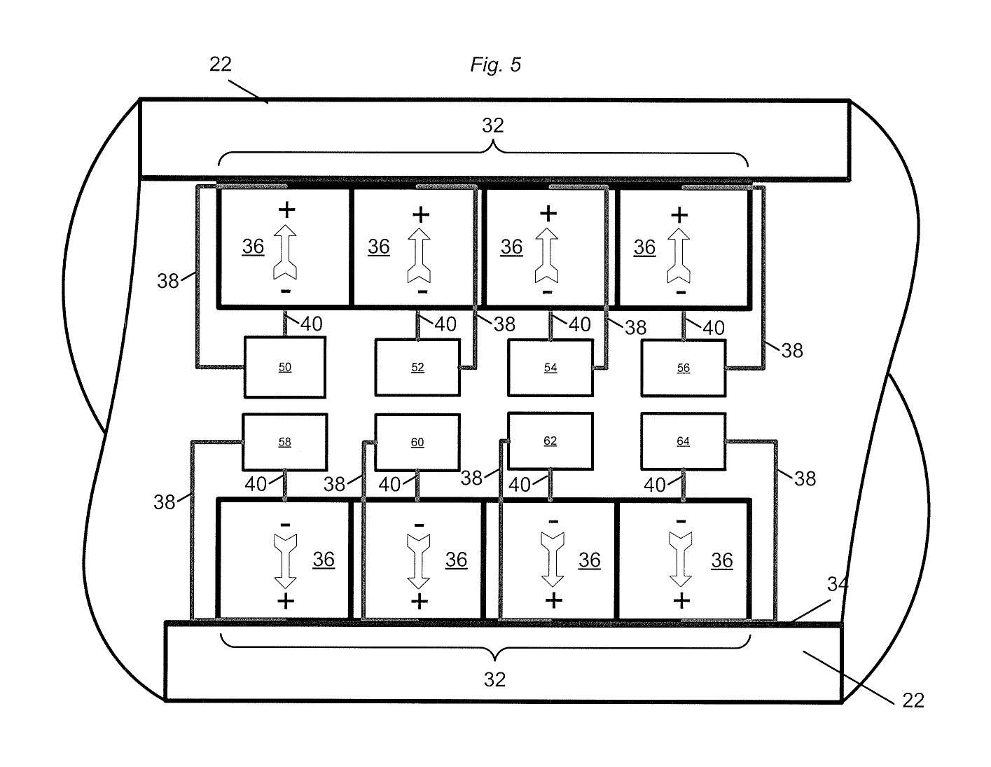

As illustrated in FIG. 5, each element 36 in the assemblies 32 is polarized as described above with respect to FIGS. 3 and 4. In this embodiment, each element 36 includes a respective load 50-64. Each element 36 generates a respective voltage, as described above with respect to FIGS. 3 and 4, when a strain is applied. As discussed in more detail below, the loads 50-64 may be passive, active, or any combination thereof. In other embodiments, each element 36 of the assembly 32 is electrically connected in series with adjacent elements. A single load is then connected to each assembly 32. For example, loads 50-56 are replaced with one load.

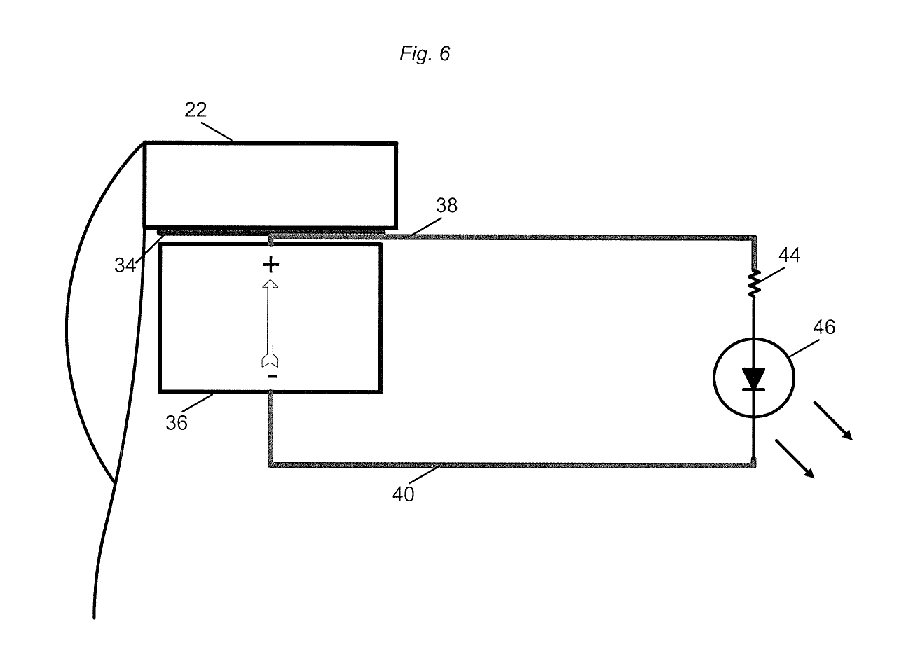

In some embodiments of the invention, the voltage generated by the elements 36 is used to provide a signal to a rider related to the vibration dampened by the assembly, as illustrated in FIG. 6. The elements 36, for example, are connected to a load that includes a current-limiting resistor 44 and a light emitting diode (LED) 46. For example, the resistor 44 can be a surface mount chip resistor and the LED 46 can be a surface mount LED. The LED 46 is connected through the current-limiting resistor 44 to an electrode contacting one or more of the piezoelectric elements 36 in the vibration dampening assembly 32. The LED 46 lights and/or flashes as the piezoelectric elements 36 are subjected to strain and dissipate the energy thereof. In some embodiments, the LED 46 will flash ON and OFF at the frequency of the disturbance that the handlebar 22 is experiencing, though the flashing may not always be visible to the naked eye. Additionally, the brightness of the LED 46 can provide an indication of the magnitude of the disturbance. Damage to the dampening system is indicated by the LED 46 failing to illuminate when the handlebar 22 is subjected to a strain. Particular defects, such as a partially-broken piezoelectric element 36, may be indicated by a weak light output. Therefore, the LED 46 provides visible confirmation to a rider that the dampening system is functioning properly.

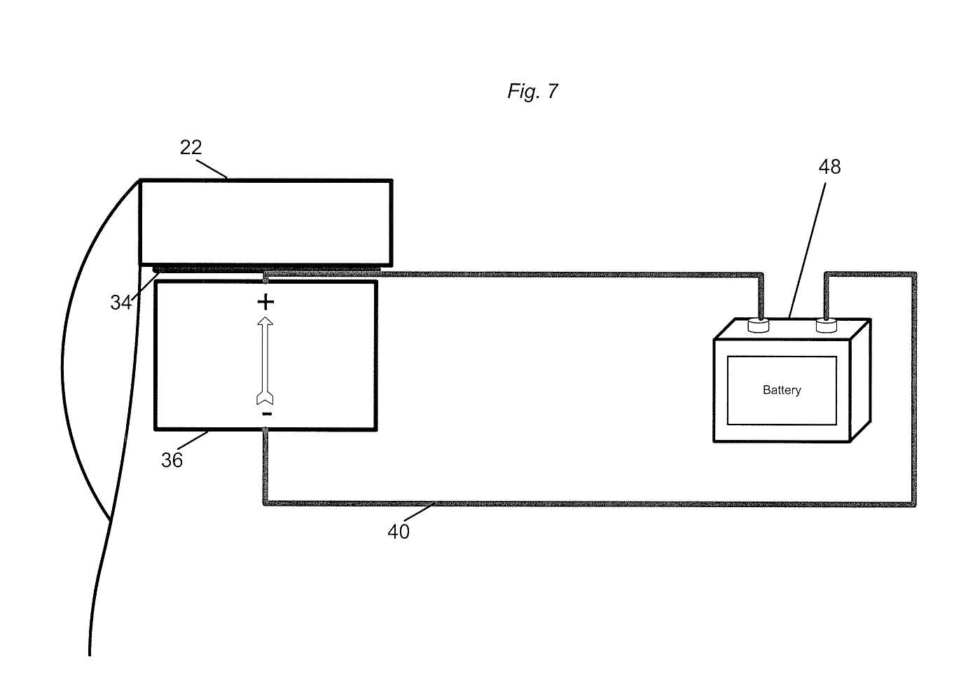

In another embodiment, the energy generated by the elements 36 is used to charge a battery, as illustrated in FIG. 7. The first lead 38 and the second lead 40 for each load are coupled to a battery 48. The DC voltage generated by the vibration dampening assemblies 32 charge the battery 48. The energy stored in the battery 48 can then be used as a secondary power supply to power aspects of the motorcycle such as lights, a radio, or an on-board computer. In other embodiments of the invention, different methods of charging are used.

In some embodiments, the electrical loads 50-64 are configured such that, when placed across one or more of the piezoelectric elements 36, the electrical properties of the loads 50-64 (i.e. capacitance, resistance, and inductance, etc.) form a filter or resonant circuit at a respective frequency. The resonant circuits operate to enhance and more efficiently dissipate energy from the piezoelectric elements 36 at a respective frequency. In some embodiments, the loads include, for example, a resistor, a capacitor, and an inductor to form a resistor-inductor-capacitor (RLC) network. The RLC network's resistor, capacitor, and inductor values are chosen based on a predetermined vibrational frequency to be dampened. For example, in many instances, a motorcycle 10 has a natural frequency at which it produces a significant mechanical vibration. In addition to the natural frequency, dynamic factors such as an engine's rotations per minute (RPM), which constantly change during the normal course of operation, contribute to the amount and degree of mechanical vibration a rider experiences. In one embodiment, each electrical load 50-64 is at a different resonant value. For example, the piezoelectric elements 36 can include a first electrical load effective at a lower resonant value, and a second electrical load effective at a higher resonant value. For example, a motorcycle 10 having an engine idle of 7000 RPM could include a filter effective at a resonant value of 117 Hertz (7000 RPM/60 seconds=117 Hertz). Other embodiments include additional loads at different resonant values.

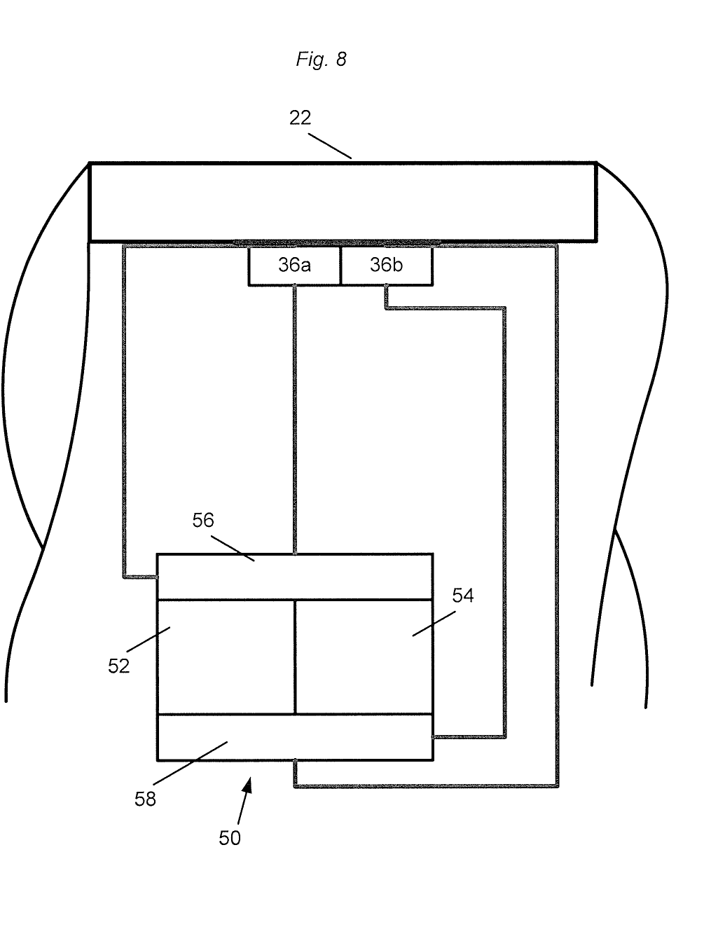

In additional embodiments, at least one of the vibration dampening assemblies 32 is an active dampening system. In contrast to the passive system, the active system applies a voltage to the piezoelectric elements 36. For example, as illustrated in FIG. 8, a sensor or a first piezoelectric element 36a detects a strain or vibration that the handlebar 22 is experiencing. The sensor or the first piezoelectric element 36a outputs a proportional voltage to a controller 50 (functioning as a load device). The controller 50, in turn, actuates a second piezoelectric element 36b to actively stiffen the handlebar 22 in a direction opposite the strain and dampen the mechanical vibrations it is experiencing. The controller 50 can include, among other things, a processor 52, a memory module 54, an input module 56, and an output module 58. The input module 56 is configured to receive a signal from the first piezoelectric element 36a related to a vehicle condition (e.g., a vibration or a strain), and the output module 58 is configured to send a signal to the second piezoelectric element 36b. In embodiments of the invention, the active circuit includes amplifying elements, processing elements, phase-shifting elements, filtering elements, switching elements, logic discrimination elements, or any combination thereof.

In other embodiments, the applied voltage is proportional to a condition of the motorcycle 10. For example, the controller 50 is connected to an on-board computer that includes information related to one or more of current motorcycle conditions. The controller 50 is programmed to accept signals from the on-board computer related to the conditions. The controller 50 recognizes the condition and outputs a signal necessary to effectively dampen the vibration. For example, the current motorcycle conditions can include conditions such as speed and RPM. In many instances, the most prominent cause of mechanical vibration experienced by the handlebar 22 is the RPM of the engine 18. As the RPM of the engine 18 changes, the frequency and amplitude of the vibration experienced at the handlebar 22 can change. The controller 50 is configured to continuously accept the signals and adjust its output to the active piezoelectric elements 36. In some embodiments, the output of the controller 50 is amplified or phase shifted in order to more effectively dampen vibrations. In other embodiments, the controller 50 saves previous signals related to a first condition of the motorcycle 10 and establishes an output set point for the first condition. The output set point is a value for the first condition of the motorcycle 10 that most effectively dampens the vibration. The output set point can be constantly adjusted by the controller 50. The output set point and a current output value related to the first condition of the motorcycle 10 are then used in a feedback mechanism, such as, for example, a proportional-integral-derivative controller (PID controller) to output a corrective signal to dampen the vibration.

In additional embodiments of the invention, vibration dampening assemblies are incorporated into different portions of the motorcycle 10, for example, in a steering apparatus, as well as into other vehicles such as bicycles, boats, planes, trains, automobiles, all-terrain vehicles, snowmobiles, and the like to dampen vibrations experienced by a rider or passenger.

Thus, the invention provides, among other things, systems and methods for dampening mechanical vibrations in a handlebar. Various features and advantages of the invention are set forth in the following claims.

What is claimed is:

1. A motorcycle rider interface, comprising:
a surface; and
a vibration dampening assembly affixed to the surface, the vibration dampening assembly including a piezoelectric element and a load element, the piezoelectric element producing an electrical energy in response to a strain on the rider interface;
wherein the load element is electrically connected to the piezoelectric element, and wherein the vibration dampening assembly is configured to dampen vibrations of the rider interface.

2. The rider interface of claim 1, wherein the surface is one of an interior surface and an exterior surface of the rider interface.

3. The rider interface of claim 1, wherein the load element converts at least a portion of the electrical energy to thermal energy.

4. The rider interface of claim 1, wherein the load element uses at least a portion of the electrical energy to provide an indication related to the vibration dampened by the vibration dampening assembly.

5. The rider interface of claim 1, wherein the load element is tuned to a predetermined frequency.

6. The rider interface of claim 1, further comprising
an active dampening system configured to counteract a strain on the rider interface, the active dampening system coupled to the vibration dampening assembly and driven by at least one motorcycle condition.

7. The rider interface of claim 6, further comprising
a controller configured to control the active dampening system, the controller including a memory module, an input module configured to receive a signal related to the motorcycle condition, and an output module configured to send a signal to the vibration dampening assembly, wherein the active dampening system is configured to dampen a vibration related to the motorcycle condition.

8. The rider interface of claim 6, wherein the motorcycle condition is a rotational frequency of an engine.

9. The rider interface of claim 1, further comprising
a filter coupled to the vibration dampening assembly, the filter configured to isolate a range of vibrational frequencies to be dampened.

10. The rider interface of claim 1, wherein the vibration dampening assembly is affixed to the surface via an adhesive.

11. The rider interface of claim 1, wherein the rider interface is a handlebar.

12. A motorcycle, comprising:
a frame;
an engine;
a rider interface including a surface; and
a vibration dampening assembly affixed to the surface, the vibration dampening assembly including a piezoelectric element and a load element, the piezoelectric element producing an electrical energy in response to a strain on the rider interface;
wherein the load element is connected to the piezoelectric element, and the vibration dampening assembly is configured to dampen vibrations of the rider interface.

13. The motorcycle of claim 12, wherein the surface is one of an interior surface and an exterior surface of the rider interface.

14. The motorcycle of claim 12, further comprising
an active dampening system configured to counteract a strain on the rider interface, the active dampening system coupled to the vibration dampening assembly, the active dampening system driven by at least one motorcycle condition.

15. The motorcycle of claim 14, further comprising
a controller configured to control the active dampening system, the controller including a memory module, an input module configured to receive a signal related to the motorcycle condition, and an output module configured to send a signal to the vibration dampening assembly, wherein the active dampening system is configured to dampen a vibration related to the motorcycle condition.

16. The motorcycle of claim 14, further comprising
a filter coupled to the vibration dampening assembly, the filter configured to isolate a range of vibrational frequencies to be dampened.

17. The motorcycle of claim 14, wherein the motorcycle condition is a rotational frequency of an engine.

18. A method of dampening a vibration in a motorcycle, comprising:
affixing a vibration dampening assembly to a surface of a rider interface, the vibration dampening assembly including a piezoelectric element;
electrically connecting a load to the vibration dampening assembly;
converting with the piezoelectric element a strain on the vibration dampening assembly to an electrical signal; and
dissipating the electrical signal by the load to dampen the vibration.

19. The method of claim 18, wherein at least a portion of the electrical signal is converted to thermal energy to dissipate the electrical signal.

20. The method of claim 18, wherein at least a portion of electrical energy is converted to provide an indication related to the vibration dampened by the vibration dampening assembly.

21. The method of claim 18, further comprising
providing a filter to tune the vibration dampening assembly to a predetermined frequency to dampen the vibration at the predetermined frequency.
